(19) United States
(12) Patent Application Publication
(10) Pub. No.: US 2012/0102083 A1
(43) Pub. Date: Apr. 26, 2012

(54) FOURIER TRANSFORM PROCESSOR

(75) Inventors: Yoshikazu Miyanaga, Sapporo (JP); Shingo Yoshizawa, Sapporo (JP)

(73) Assignee: RayTron, Inc., Osaka-shi (JP)

(21) Appl. No.: 13/253,148

(22) Filed: Oct. 5, 2011

(30) Foreign Application Priority Data
Oct. 22, 2010 (JP) 2010-237225

(51) Int. Cl. G06F 17/14

(52) U.S. Cl. 708/409

(57) ABSTRACT

A Fourier transform processor that is used in wireless communication includes: a Fourier transform mechanism including a butterfly unit and configured to perform a Fourier transform on data that is input to the Fourier transform processor; a first memory configured to store the data that is input to the Fourier transform mechanism; a first commutator configured to rearrange the data that is input to the first memory; and a second commutator configured to rearrange the data that is output from the first memory and that is input to the butterfly unit. This configuration allows the size and power consumption of the Fourier transform processor to be reduced.

### TECHNICAL FIELD

The present invention relates to Fourier transform processors, and more particularly to Fourier transform processors for use in wireless communication.

### BACKGROUND ART

A multi input multi output-orthogonal frequency division multiplexing (MIMO-OFDM) transmission method is employed in the IEEE 802.11n standard that has recently been used in wireless communication uses. In the MIMO-OFDM transmission method, a Fourier transform and an inverse transform are required to transmit and receive data in a wireless manner.

In the IEEE 802.11n standard, a Fourier transform is performed at 128 points in a single data stream. Such a Fourier transform processor is disclosed in, e.g., Yu-Wei Lin, et al., “Design of an FFT/IFFT Processor for MIMO OFDM Systems,” IEEE Trans, CAS-I, vol. 54, pp. 807-815, April 2007. (Non Patent Literature 1)

### NON PATENT LITERATURE

[Non Patent Literature 1] Yu-Wei Lin, et al., “Design of an FFT/IFFT Processor for MIMO OFDM Systems,” IEEE Trans, CAS-I, vol. 54, pp. 807-815, April 2007.

FIG. 11 is a diagram showing a circuit configuration of a conventional Fourier transform processor 100 disclosed in Non Patent Literature 1. Referring to FIG. 11, the Fourier transform processor 100 includes a radix-8 multi-path delay commutator (R8MDC) 101, radix-2 single-path delay feedbacks (R2SDFs) 104, a first memory 102 configured to store data that is input to the R8MDC 101, and a second memory 103 configured to store data that is output from the R2SDFs 104. In the Fourier transform processor 100, the number of data streams is 8, and the number of Fourier transform points in each data stream is 128.

FIG. 12 is a diagram showing a circuit configuration of the conventional R8MDC 101. Referring to FIG. 12, the R8MDC 101 includes a delay element (DE) 200, a commutator 201, a delay element 202, a first butterfly operation circuit (hereinafter, “a butterfly operation circuit” is referred to as “a butterfly unit”) 203, a complex multipliers (hereinafter referred to as “non-trivial multipliers”) 204, a delay element 205, a commutator 206, a delay element 207, and a second butterfly unit 208. The delay element 200 includes a plurality of delay units having different delay amounts from each other. The delay amounts x are respectively shown in the delay units in FIG. 12 (DE:x). For example, the delay amount x of a delay unit 200a is 56. Similarly, each of the other delay elements 202, 205, 207 includes a plurality of delay units having different delay amounts from each other. FIG. 13 is a diagram showing a circuit configuration of the R2SDF 104. Referring to FIG. 13, the R2SDF 104 also includes a delay unit 104a.

FIG. 14 is a diagram showing data that is output from the first memory 102 into the R8MDC 101. FIG. 15 is a diagram showing data that is input to the first butterfly unit 203 of the R8MDC 101. The R8MDC 101 rearranges the data shown in FIG. 14 to the arrangement shown in FIG. 15 by the delay elements 200, 202 and the commutator 201. That is, the data shown in FIG. 14 needs to have the arrangement of FIG. 15 when being input to the first butterfly unit 203. Thus, the data in FIG. 14 needs to be rearranged.

Implementing the above delay elements in hardware requires shift registers, etc., which increases the size of the configuration of the Fourier transform processor. It is therefore preferable to reduce the number of delay elements as much as possible. Moreover, providing a plurality of delay elements increases the overall power consumption of the delay elements, and thus increases power consumption of the Fourier transform processor.

### SUMMARY OF INVENTION

It is an object of the present invention to provide a Fourier transform processor having reduced power consumption and a reduced size.

A Fourier transform processor according to the present invention is used in wireless communication. The Fourier transform processor includes: a Fourier transform mechanism including a butterfly operation circuit and configured to perform a Fourier transform on data that is input to the Fourier transform processor; a first memory configured to store the data that is input to the Fourier transform mechanism; a first commutator configured to rearrange the data that is input to the first memory; and a second commutator configured to rearrange the data that is output from the first memory and that is input to the butterfly operation circuit.

Thus, the Fourier transform processor can rearrange the received data for input to the butterfly operation circuit, by using the first commutator and the second commutator. Since the data can be rearranged without providing delay elements, the size of the Fourier transform processor can be reduced, and power consumption thereof can be reduced.

Preferably, the Fourier transform processor further includes: a second memory configured to store the data that is output from the Fourier transform mechanism; a third commutator configured to rearrange the data that is input to the second memory; and a fourth commutator configured to rearrange the data that is output from the second memory.

More preferably, the Fourier transform processor satisfies m=2^{s,} where “m” represents the number of data streams and “s” represents a natural number, and the Fourier transform processor satisfies n=2^{t,} where “n” represents the number of Fourier transform points in each data stream and “t” represents a natural number. Thus, the Fourier transform processor can be applied to various numbers of streams and various numbers of Fourier transform points.

In an embodiment, in the Fourier transform processor, the number of data streams is 8, and the number of Fourier transform points in each of the data streams is 128.

The Fourier transform processor of the present invention can rearrange the received data for input to the butterfly unit, by using the first commutator and the second commutator. Since the data can be rearranged without providing delay elements, the size of the Fourier transform processor can be reduced, and power consumption thereof can be reduced.

### BRIEF DESCRIPTION OF DRAWINGS

FIG. 1 is a diagram showing a circuit configuration of a Fourier transform processor according to an embodiment of the present invention.

FIG. 2 is a diagram showing a detailed circuit configuration of a first commutator, a second commutator, and a first memory.

FIG. 3 is a schematic diagram showing the first memory.

FIG. 4 is a diagram showing an example of data that is input to the first commutator.

FIG. 5 is a diagram showing an example in which the data in FIG. 4 is divided into groups of 16 points.

FIG. 6 is a diagram showing an arrangement of data that is obtained by rearranging the data of FIG. 5 and that is output from the first commutator.

FIG. 7 is a diagram showing an arrangement of data obtained from the data of FIG. 6 and written in the first memory 13 by controlling write positions.

FIG. 8 is a diagram showing an arrangement of data that is obtained by rearranging the data of FIG. 7 and that is output from the second commutator to a first butterfly unit.

FIG. 9 is a table showing power consumption.

FIG. 10 is a table showing a circuit area.

FIG. 11 is a diagram showing a circuit configuration of a conventional Fourier transform processor disclosed in Yu-Wei Lin, et al., “Design of an FFT/IFFT Processor for MIMO OFDM Systems,” IEEE Trans, CAS-I, vol. 54, pp. 807-815, April 2007.

FIG. 12 is a diagram showing a circuit configuration of a conventional R8MDC.

FIG. 13 is a diagram showing a circuit configuration of an R2SDF.

FIG. 14 is a diagram showing data that is output from a first memory into the R8MDC.

FIG. 15 is a diagram showing data that is input to a first butterfly unit of the R8MDC.

### DESCRIPTION OF EMBODIMENTS

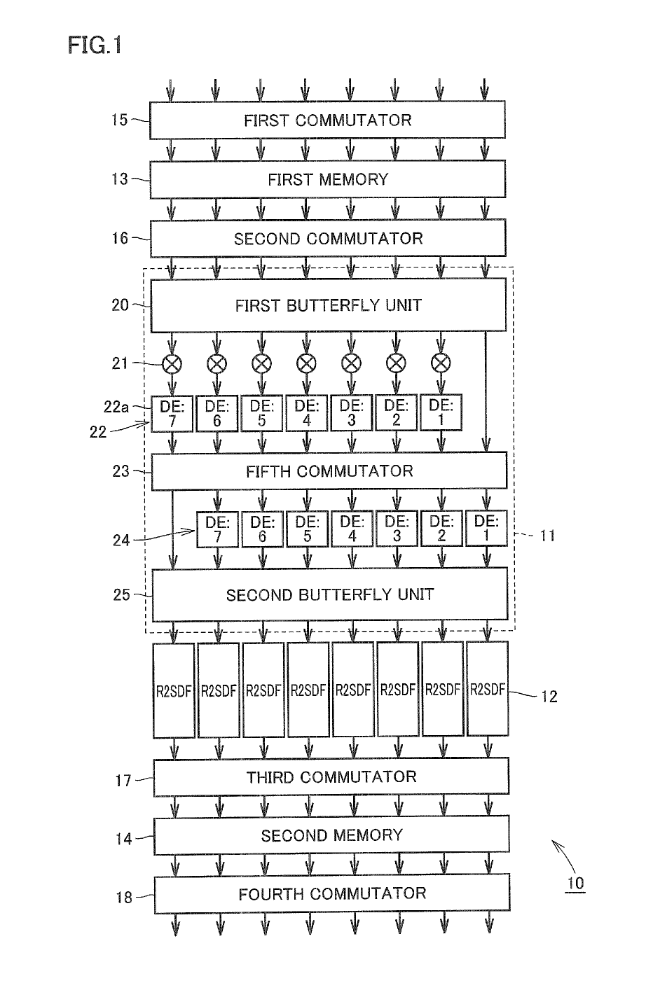

A Fourier transform processor according to an embodiment of the present invention will be described below with reference to the accompanying drawings. FIG. 1 is a diagram showing a circuit configuration of a Fourier transform processor 10 according to an embodiment of the present invention. Referring to FIG. 1, the Fourier transform processor 10 includes: a Fourier transform mechanism 11 configured to perform a Fourier transform on data that is input to the Fourier transform processor 10; radix-2 single-path delay feedbacks (R2SDFs) 12; a first memory (an input random access memory (RAM)) 13 configured to store the data that is input to the Fourier transform mechanism 11; a second memory (an output RAM) 14 configured to store the data that is output from the Fourier transform mechanism 11; a first commutator (a pre-commutator) 15 configured to rearrange the data that is input to the first memory 13; a second commutator (a post-commutator) 16 configured to rearrange the data that is output from the first memory 13; a third commutator (a pre-commutator) 17 configured to rearrange the data that is input to the second memory 14; and a fourth commutator (a post-commutator) 18 configured to rearrange the data that is output from the second memory 14. In the Fourier transform mechanism 10, the number of data streams is 8, and the number of Fourier transform points in each data stream is 128. That is, the Fourier transform processor 10 is an 8-stream type processor.

The first commutator 15, the second commutator 16, and the first memory 13 are placed on the input side of the Fourier transform mechanism 11, and the third commutator 17, the fourth commutator 18, and the second memory 14 are placed on the output side of the Fourier transform mechanism 11. When data is input to the first commutator 15 on the input side, the Fourier transform processor 10 performs a Fourier transform on the data to output the resultant data up to the fourth commutator 18 on the output side. The data flow is shown by arrows in FIG. 1.

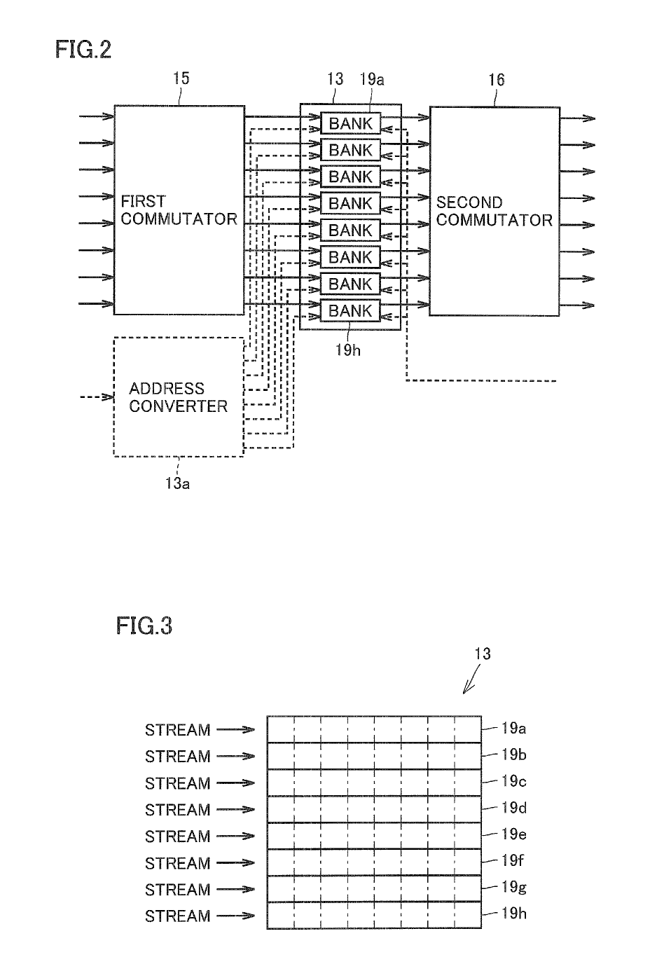

FIG. 2 is a diagram showing a detailed circuit configuration of the first commutator 15, the second commutator 16, and the first memory 13. Referring to FIG. 2, the first commutator 15 receives and outputs 8 data streams. The second commutator 16 operates similarly to the first commutator 15. The first memory 13 is an 8-bank dual port RAM. FIG. 3 is a schematic diagram of the first memory 13. Referring to FIG. 3, the first memory 13 includes 8 banks 19a to 19h. Note that in FIG. 2, only two of the banks, 19a and 19h, are denoted with reference characters. The 8 banks 19a to 19h are provided for the data streams. That is, one bank is used per data stream, and thus the 8 banks are provided for the 8 data streams. In each bank of the first memory 13, data in a single data stream (128 points) is divided into eight data pieces before being written to the bank of the first memory 13. That is, the data pieces are written in 8 rows by 8 columns in the first memory 13. The first memory 13 includes an address converter 13a, and the address converter 13a controls data write positions in the first memory 13. The data is output from the first commutator 15 to the second commutator 16 via the first memory 13.

The Fourier transform mechanism 11 is a radix-8 multi-path delay commutator (R8MDC), and includes a first butterfly unit 20, non-trivial multipliers 21, a delay element (DE) 22, a fifth commutator 23, a delay element 24, and a second butterfly unit 25.

The delay element 22 includes a plurality of delay units having different delay amounts from each other. The delay amounts x are respectively shown in the delay units in FIG. 1 (DE:x). For example, the delay amount x of a delay unit 22a is 7. The delay element 24 similarly includes a plurality of delay units having different delay amounts from each other.

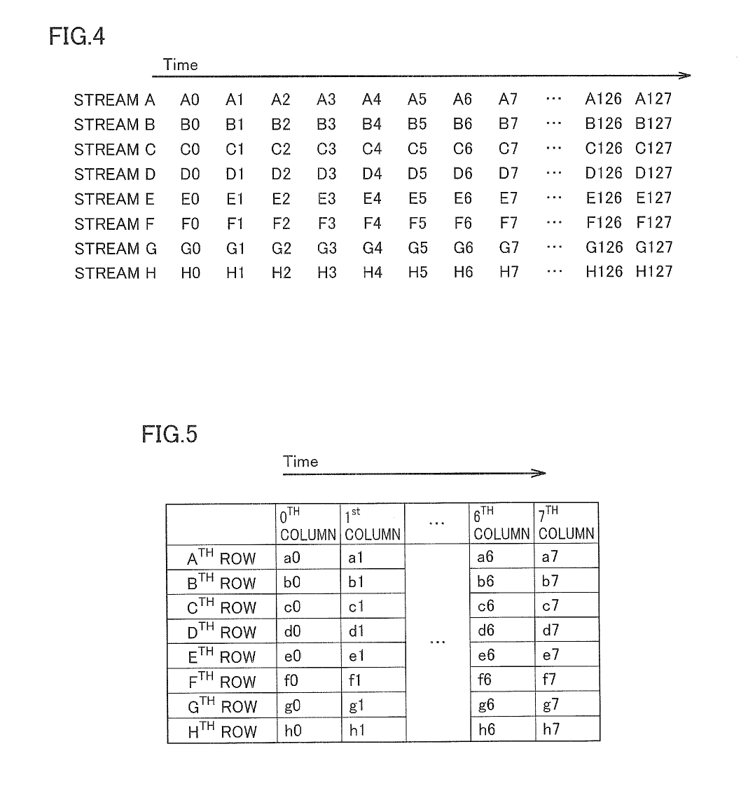

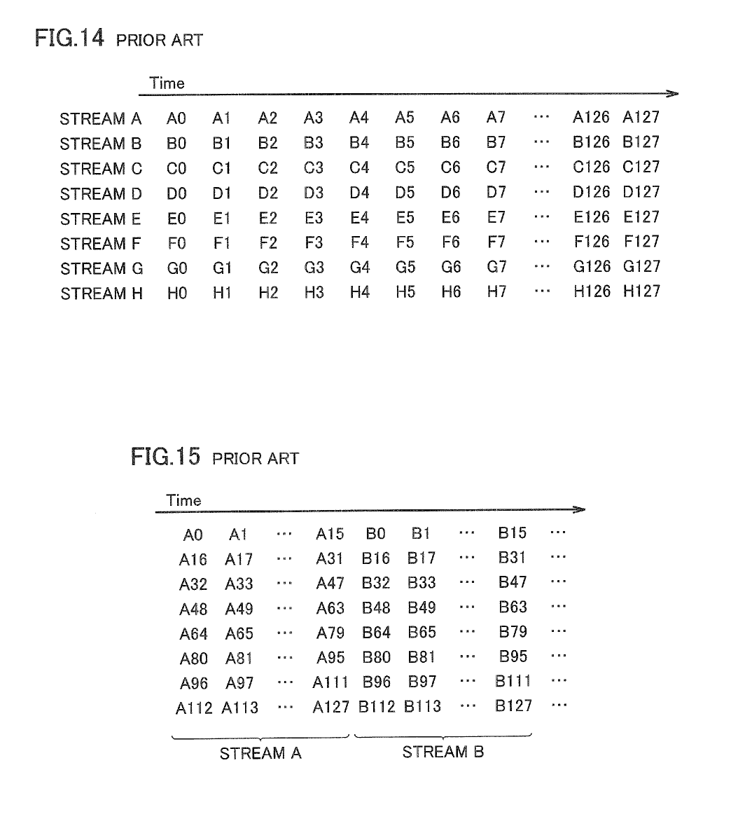

FIG. 4 is a diagram showing an example of data that is input to the first commutator 15. Referring to FIG. 4, the data is formed by 8 streams A to H. Each of the data streams is formed by 128 points 0 to 127. For example, the stream A is formed by points A0 to A127, and the stream B is formed by points B0 to B127. That is, the data that is input to the first commutator 15 is in 8 rows and 128 columns. The data that is input to the first commutator 15 is data that is input to the Fourier transform processor 10. Note that the data in FIG. 4 is the same as the data in FIG. 14.

For description, the points are divided into groups of 16 points. FIG. 5 is a diagram showing an example in which the points of the data in FIG. 4 are divided into groups of 16 points. Referring to FIG. 5, “a0” in the A^{th} row in the 0^{th} column represents the points A0 to A15 in the stream A of FIG. 4, and “b0” in the B^{th} row in the 0^{th} column represents the points B0 to B16 in the stream B in FIG. 4. Similarly, each of “c0,” “d0,” . . . , and “h0” represents points 0 to 15 in a corresponding one of the streams. “a1” in the A^{th} row in the 1^{st} column represents the points A16 to A31. Similarly, each of “b1,” “c1,” . . . , and “h1” represents points 6 to 31 in a corresponding one of the streams. In the case where the points are thus divided into the groups of 16 points, the data that is input to the first commutator 15 is in 8 rows and 8 columns.

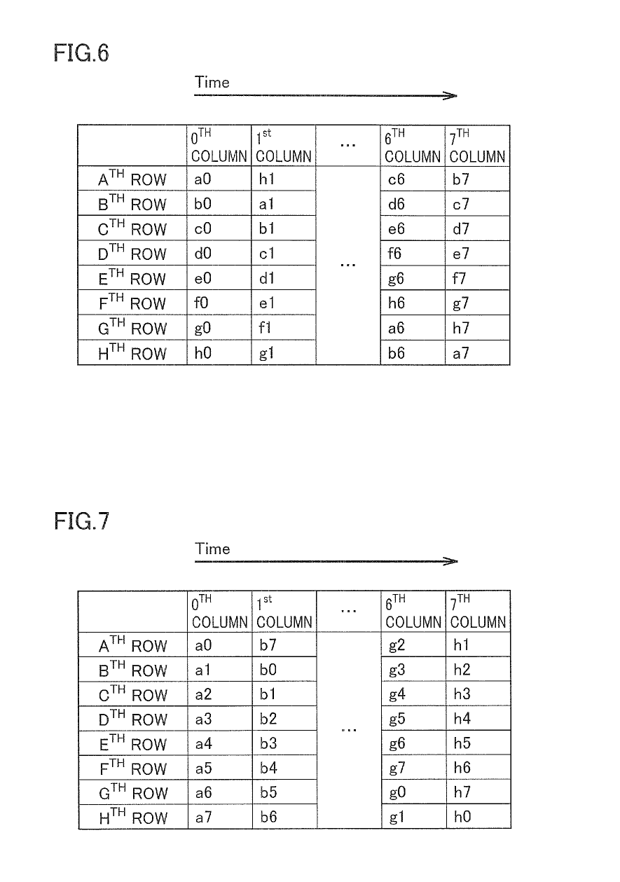

When the data of FIG. 5 is input to the first commutator 15, the first commutator 15 rearranges the data. FIG. 6 is a diagram showing an arrangement of the data that is obtained by rearranging the data of FIG. 5 in the first commutator 15 and that is output from the first commutator 15. Referring to FIGS. 5 and 6, the data in the 0^{th} column in FIG. 6 is the same as that in FIG. 5. That is, in the 0^{th} column, each data piece is moved by 0 rows. In the 1^{st} column, “a1” is moved downward by one row, namely from the A^{th} row to the B^{th} row, and each of “b1,” “c1,” . . . , and “g1” are similarly moved downward by one row. Since “h1” is in the H^{th} row in FIG. 5 and cannot be moved downward by one row, “h1” is moved up from the H^{th} row to the A^{th} row. That is, in the 1^{st} column, each data piece is moved downward by one row, and in other columns, e.g., in the 6^{th} column, each data piece is moved downward by 6 rows, and in the 7^{th} column, each data piece is moved downward by 7 rows. That is, each data piece is moved downward by a corresponding number of columns. The first commutator 15 thus rearranges the data by moving each data piece downward by a corresponding number of rows. The first commutator 15 outputs the data rearranged as shown in FIG. 6 to the first memory 13.

The data thus output to the first memory 13 is written from the first commutator 15 to the first memory 13 by the address converter 13a. At this time, the address converter 13a controls write positions of the data. FIG. 7 is a diagram showing an arrangement of the data rearranged from the data in FIG. 6 and written in the first memory 13. Referring to FIGS. 6 and 7, “a0” is located at the same position, namely in the 0^{th} column in the A^{th} row. That is, the address converter 13a controls the write positions so that “a0” in the 0^{th} column in the A^{th} row is written in the same position, that “a1” in the 1^{st} column in the B^{th} row is written in the 0^{th} column in the B^{th} row, row that “a6” in the 6^{th} column in the G^{th} row is written in the 0^{th} column in the G^{th} row, and that “a7” in the 7^{th} column in the H^{th} row is written to the 0^{th} column in the H^{th} row. The address converter 13a controls the write positions of “a2,” “a3,” . . . , and “a5” in a similar manner. That is, the address converter 13a controls the write positions so that each of “a0,” “a1,” . . . , and “a7” as the data groups of the stream A, each located in a corresponding column in a corresponding row, is written in the 0^{th} column in the corresponding row.

The address converter 13a controls the write positions of the data of the stream B, e.g., the write position of “b7,” so that “b7” in the 7^{th} column in the A^{th} row is written in the 1^{st} column in the A^{th} row. Similarly, the address converter 13a controls the write positions of “b0,” “b1,” . . . , and “b6” so that each of “b0,” “b1,” . . . , and “b6”, each located in a corresponding column in a corresponding row, is written in the 1^{st} column in the corresponding row. The address converter 13a controls the write positions of the data of the stream C so that each data piece in a corresponding column in a corresponding row is written in the 2^{nd} column in the corresponding row. Similarly, the address converter 13a controls the write positions of the data pieces of the streams D, E, . . . , and H so that each data piece in each stream D, E, . . . , and H, which is located in a corresponding column in a corresponding row, is written to the 3, 4, . . . , and 7^{th} column in the corresponding column, respectively. The address converter 13a thus controls the write positions of the data to write the data in the first memory 13.

Referring to FIG. 7, the data pieces “a0” to “a7” of the stream A are sequentially arranged in the 0^{th} column. The data pieces “b0” to “b7” of the stream B are sequentially arranged in the 1^{st} column. In the 2^{nd} column and the subsequent columns, the data pieces are sequentially arranged in a similar manner. The data having the arrangement of FIG. 7 is read from the first memory 13 to the second commutator 16.

When the data in FIG. 7 is input to the second commutator 16, the second commutator 16 rearranges the data, and outputs the rearranged data to the first butterfly unit 20 of the Fourier transform mechanism 11. FIG. 8 is a diagram showing the arrangement of the data that is obtained by rearranging the data of FIG. 7 in the second commutator 16 and that is output from the second commutator 16 to the first butterfly unit 20. Referring to FIGS. 7 and 8, the data in the 0^{th} column in FIG. 8 is the same as that in FIG. 7. That is, in the 0^{th} column, each data piece is moved by 0 rows. In the 1^{st} column, “b0” is moved upward by one row, namely from the B^{th} row to the A^{th} row, and each of “b1,” “b2,” . . . , and “b6” are similarly moved upward by one row. Since “b1” is in the A^{th} row in FIG. 7 and cannot be moved upward by one row, “b1” is moved down from the A^{th} row to the H^{th} row. That is, in the 1^{st} column, each data piece is moved upward by one row, and in other columns, e.g., in the 6^{th} column, each data piece is moved upward by 6 rows, and in the 7^{th} column, each data piece is moved upward by 7 rows. That is, each data piece is moved upward by a corresponding number of columns. The second commutator 16 thus rearranges the data by moving each data piece upward by a corresponding number of rows. The second commutator 16 outputs the data rearranged as shown in FIG. 8 to the first butterfly unit 20.

Referring to FIG. 8, the data is arranged in the same manner as that of FIG. 15 in the conventional example. That is, referring to FIG. 8, “a0” in the A^{th} row in the 0^{th} column represents the points A0 to A15 in the stream A, and “a1” in the B^{th} row in the 0^{th} column represents the points A16 to A31. Thus, the stream A is in the 0^{th} column. Accordingly, the Fourier transform processor 10 of the present invention can rearrange the data for output to the first butterfly unit 20 without the delay elements as in the conventional example. The rows and columns of the data are switched between FIG. 5 showing the data before rearrangement and FIG. 8.

Thus, the Fourier transform processor 10 can rearrange the data for input to the first butterfly unit 20 of the Fourier transform mechanism 11 by using the first commutator 15 and the second commutator 16. This allows the data to be rearranged without the delay elements as in the conventional example. This can reduce the size of the Fourier transform processor 10, and can reduce the power consumption thereof.

Since the number of delay elements is reduced, the processing speed can further be increased.

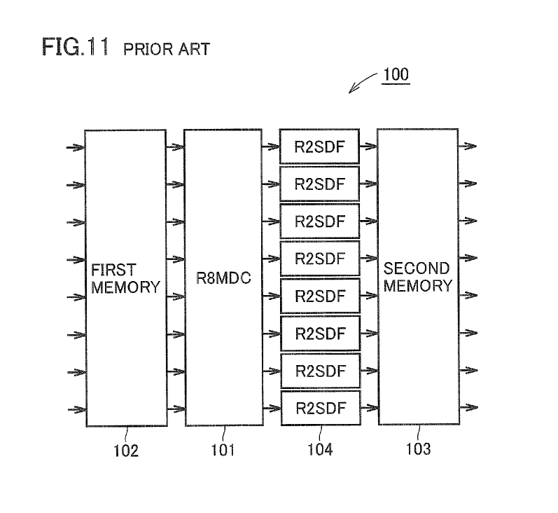

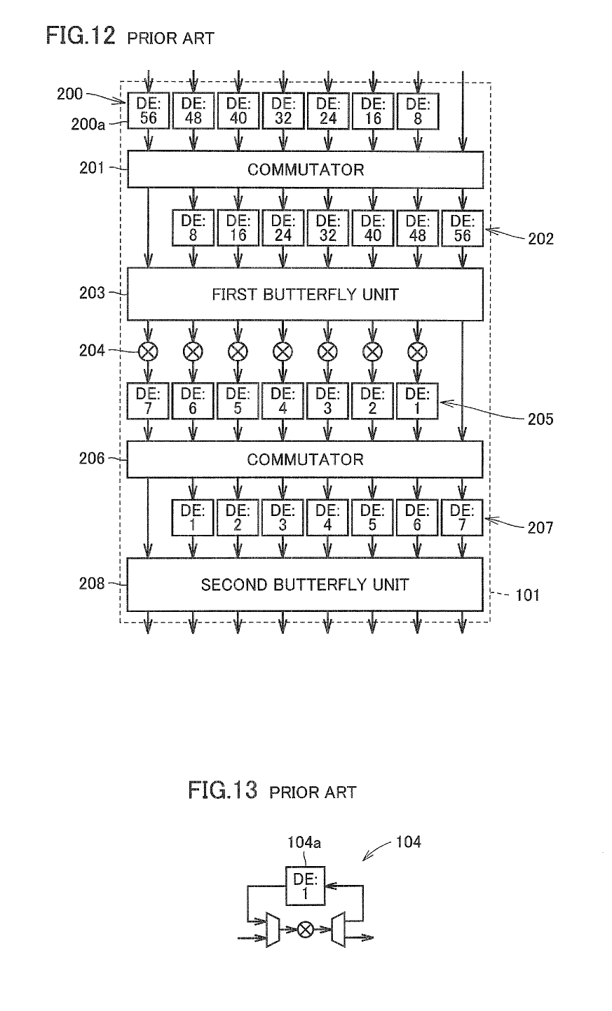

That is, the delay elements 200, 202 provided between the first memory 12 and the first butterfly unit 203 in the conventional Fourier transform processor 100 shown in FIGS. 11 and 12 can be eliminated in the Fourier transform processor 10 of the present invention shown in FIG. 1.

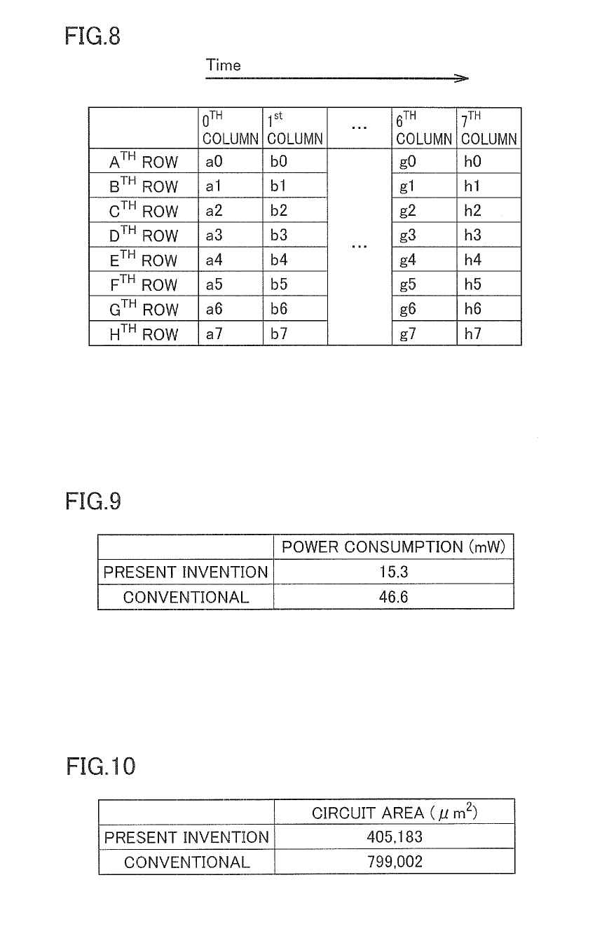

FIG. 9 is a table showing power consumption (mW) in the case where the Fourier transform processor 10 of the present invention shown in FIG. 1 and the conventional Fourier transform processor 100 shown in FIG. 11 are mounted by a 90-nm complementary metal oxide semiconductor (CMOS) technique. Referring to FIG. 9, the power consumption of the conventional Fourier transform processor 100 is 46.6 mW, whereas the power consumption of the Fourier transform processor 10 of the present invention is 15.3 mW. This shows that the power consumption can be reduced to ⅓ of the power consumption of the conventional example. Note that this evaluation of the power consumption is based on the power consumption estimated by using a computer aided design (CAD) system in the case where the power supply voltage is set to 1.0 V and the clock frequency is set to 100 MHz.

FIG. 10 is a table showing a circuit area (μm²) in the case where the Fourier transform processor 10 of the present invention shown in FIG. 1 and the conventional Fourier transform processor 100 shown in FIG. 11 are mounted by the 90-nm CMOS technique. Referring to FIG. 10, the circuit area of the conventional Fourier transform processor 100 is 799,022 μm², whereas the circuit area of the Fourier transform processor 10 of the present invention is 405,183 μm². This shows that the circuit area can be reduced by 49% from the circuit area in the conventional example.

Note that the above embodiment is described with respect to an example in which data is rearranged in the first commutator 15, the second commutator 16, and the first memory 13 on the input side of the Fourier transform mechanism 11. However, the present invention is not limited to this, and similar processing can be performed in the third commutator 17, the fourth commutator 18, and the second memory 11 on the output side of the Fourier transform mechanism 11. That is, on the output side, the data rearranged on the input side from FIG. 5 to FIG. 8 is rearranged back to the original data arrangement from FIG. 8 to FIG. 5.

Specifically, the first commutator 15 corresponds to the third commutator 17, the second commutator 16 corresponds to the fourth commutator 18, and the first memory 13 corresponds to the second memory 14. The stream A is in the A^{th} row in FIG. 8, that is, a0, b0, . . . , and h0. Similarly, the streams B, C, . . . , and H are in the B^{th} row, the C^{th} row, . . . , and the H^{th} row, respectively. The third commutator 17 receives the data arranged as shown in FIG. 8, and outputs the data arranged as shown in FIG. 7. Then, the data shown in FIG. 6 is written to the second memory 14. The fourth commutator 18 receives the data arranged as shown in FIG. 6, and outputs the data arranged as shown in FIG. 5.

Note that the above embodiment is described with respect to an example of Fourier transform. However, the present invention is not limited to this, and Fourier inverse transform may be used. In this case, the data is rearranged back to the original arrangement from FIG. 8 to FIG. 5, as in the case of the output side described above.

Although the above embodiment is described with respect to an example in which the number of data streams is 8, the present invention is applicable to multiple streams, namely 2 or more streams. For example, the present invention is applicable to multiple streams of m=2^{s,} where “m” represents the number of data streams, and “s” represents a natural number (s=1, 2, . . . ). The number of Fourier transform points is not limited to 128, and the present invention is applicable to any number of Fourier transform points. For example, the present invention is applicable to the number of points, n=2^{t}, that is independent of “m,” where “n” represents the number of points, and “t” represents a natural number (t=1, 2, . . . ).

The Fourier transform processor 10 is not limited to mounting by using full-custom large scale integration (LSI), and is applicable to mounting by using a discrete digital circuit, semi-custom LSI, a field-programmable gate array (FPGA).

Although the embodiment of the present invention is described above with reference to the drawings, the present invention is not limited to the illustrated embodiment. Various modifications and variations can be made to the illustrated embodiment within a scope that is the same as, or equivalent to the present invention.

### INDUSTRIAL APPLICABILITY

The present invention is effectively used in networks using wireless communication.

1. A Fourier transform processor that is used in wireless communication, comprising:
a Fourier transform mechanism including a butterfly operation circuit and configured to perform a Fourier transform on data that is input to said Fourier transform processor;
a first memory configured to store the data that is input to said Fourier transform mechanism;
a first commutator configured to rearrange the data that is input to said first memory; and
a second commutator configured to rearrange the data that is output from said first memory and that is input to said butterfly operation circuit.

2. The Fourier transform processor according to claim 1, further comprising:
a second memory configured to store the data that is output from said Fourier transform mechanism;
a third commutator configured to rearrange the data that is input to said second memory; and
a fourth commutator configured to rearrange the data that is output from said second memory.

3. The Fourier transform processor according to claim 1, wherein
said Fourier transform processor satisfies m=2^{s}, where “m” represents the number of data streams and “s” represents a natural number, and
said Fourier transform processor satisfies n=2^{t,} where “n” represents the number of Fourier transform points in each data stream and “t” represents a natural number.

4. The Fourier transform processor according to claim 3, wherein
the number of data streams is 8, and the number of Fourier transform points in each of said data streams is 128.
